(19) United States
(12) Patent Application Publication
(10) Pub. No.: US 2023/0094972 A1
(43) Pub. Date: Mar. 30, 2023

(54) CUSTOMER MANAGEMENT APPARATUS, CUSTOMER MANAGEMENT METHOD, AND NON-TRANSITORY COMPUTER-READABLE MEDIUM

(71) Applicant: NEC Corporation, Minato-ku, Tokyo (JP)

(72) Inventor: Yasuji SAITO, Tokyo (JP)

(73) Assignee: NEC Corporation, Minato-ku, Tokyo (JP)

(21) Appl. No.: 17/802,685

(22) PCT Filed: Dec. 9, 2020
(86) PCT No.: PCT/JP2020/045837

§ 371 Date: Aug. 26, 2022

(30) Foreign Application Priority Data
Mar. 2, 2020 (JP) 2020-034685

(51) Int. Cl. G06V 40/50; G06V 40/16; G06F 21/32; G07C 9/25; G07C 9/27; G06Q 20/40

(52) U.S. Cl. CPC G06V 40/50; G06F 21/32; G06Q 20/40145; G06V 40/172; G07C 9/25; G07C 9/27; G06F 2221/2117

(57) ABSTRACT

A customer management apparatus (10) includes an acquisition unit (110) and a determination unit (120). The acquisition unit (110) acquires, from a registration terminal (20), first face information and card identification information. When the first face information satisfies a first criterion regarding whether authentication is possible, the determination unit (120) causes a storage unit (130) to store the first face information and the card identification information in association with each other (first registration processing), and performs processing for allowing a customer to enter a store. The processing may be, for example, issuing, to a store entry apparatus (40), a command to open an automatic door, or may be issuing, to the store entry apparatus (40), a command (so-called lock releasing) to cause an automatic door to open when the customer stands in front of the automatic door.

### TECHNICAL FIELD

The present invention relates to a customer management apparatus, a customer management method, and a program.

### BACKGROUND ART

In recent years, generating a face image of a customer at an entrance of a store has been considered. For example, Patent Document 1 describes that, in a staffed store and an unstaffed store, a camera is installed at an entrance/exit, and a face image of a visitor is generated. The face image is collated with an image registered in advance in order to determine the visitor.

Patent Document 2 describes that, in an amusement store or the like, when a pattern in an area where a certain person is detected is a behavior pattern of a suspicious person, a suspicious person flag is temporally registered with respect to a face image of the person, and in a case where the face image of the person is captured at a prize exchange counter, the suspicious person flag is actually registered.

Further, Patent Document 3 describes that, in a system for managing entrance and exit of a person at a store, at least an image including a face of the person, and information on an IC card carried by the person are registered as personal information for using the store.

### RELATED DOCUMENT

### Patent Document

[Patent Document 1] International Publication No. WO2019/191364
[Patent Document 2] Japanese Patent Application Publication No. 2012-141773
[Patent Document 3] Japanese Patent Application Publication No. 2009-9231

### SUMMARY OF THE INVENTION

### Technical Problem

In recent years, operating a store by a small number of people or in an unstaffed manner has been considered. In this case, since it is necessary to secure safety within a store, a customer who is about to enter the store is required to take a certain procedure. On the other hand, when a level of the security is too high, a customer feels it difficult to enter the store, because the level of a procedure required for the customer at a time of entering the store increases.

One example of an object of the present invention is to set a requirement level of security within a store to an appropriate state in a case where the store is operated by a small number of people or in an unstaffed manner.

### Solution to Problem

The present invention provides a customer management apparatus including:
an acquisition unit that acquires, from a registration terminal installed at an entrance of a first store, first face information of a customer who wishes to enter the first store, and customer unique information being information uniquely allocated to the customer; and,
when the first face information satisfies a first criterion regarding whether authentication is possible, a determination unit that performs first registration processing of causing a storage unit to store the first face information and the customer unique information in association with each other, and performing processing for allowing the customer to enter the first store.

The present invention provides a customer management method including, by a computer:
acquiring, from a registration terminal installed at an entrance of a first store, first face information of a customer who wishes to enter the first store, and customer unique information being information uniquely allocated to the customer; and,
when the first face information satisfies a first criterion regarding whether authentication is possible, performing first registration processing of causing a storage unit to store the first face information and the customer unique information in association with each other, and performing processing for allowing the customer to enter the first store.

The present invention provides a program causing a computer to execute:
acquiring, from a registration terminal installed at an entrance of a first store, first face information of a customer who wishes to enter the first store, and customer unique information being information uniquely allocated to the customer; and,
when the first face information satisfies a first criterion regarding whether authentication is possible, performing first registration processing of causing a storage unit to store the first face information and the customer unique information in association with each other, and performing processing for allowing the customer to enter the first store.

### Advantageous Effects of Invention

The present invention enables setting a requirement level of safety within a store to an appropriate state in a case where the store is operated by a small number of people or in an unstaffed manner.

### BRIEF DESCRIPTION OF THE DRAWINGS

FIG. 1 is a diagram illustrating a usage environment of a customer management apparatus according to a first example embodiment.

FIG. 2 is a diagram illustrating one example of a functional configuration of the customer management apparatus.

FIG. 3 is a diagram illustrating one example of information stored in a storage unit.

FIG. 4 is a diagram illustrating a hardware configuration example of the customer management apparatus.

FIG. 5 is a flowchart illustrating first processing to be performed by the customer management apparatus.

FIG. 6 is a flowchart illustrating second processing to be performed by the customer management apparatus.

FIG. 7 is a flowchart illustrating third processing to be performed by the customer management apparatus.

FIG. 8 is a flowchart illustrating fourth processing to be performed by the customer management apparatus.

FIG. 9 is a flowchart illustrating fifth processing to be performed by the customer management apparatus.

FIG. 10 is a diagram illustrating a usage environment of a customer management apparatus according to a second example embodiment.

FIG. 11 is a flowchart illustrating processing to be performed by the customer management apparatus when a customer takes out a specific product from a product shelf.

FIG. 12 is a flowchart illustrating processing to be performed by the customer management apparatus when a customer performs checkout processing of a product by using a checkout apparatus.

### DESCRIPTION OF EMBODIMENTS

In the following, example embodiments according to the present invention are described with reference to the drawings. Note that, in all drawings, a similar constituent element is indicated by a similar reference sign, and description thereof is not repeated as necessary. Further, in the following description, face information may be a face image, or may be a feature value of a face.

### First Example Embodiment

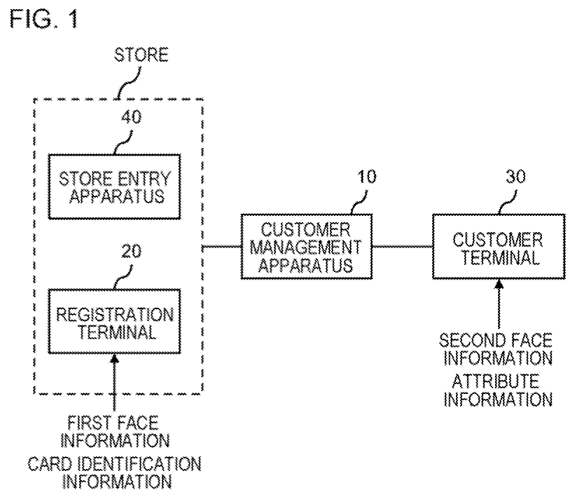

FIG. 1 is a diagram illustrating a usage environment of a customer management apparatus 10 according to a present example embodiment. The customer management apparatus 10 is used together with a registration terminal 20 installed in a store, a customer terminal 30, and a store entry apparatus 40.

The registration terminal 20 and the store entry apparatus 40 are provided in a store. The store is operated in an unstaffed manner or by a small number of people (e.g., one person or two persons) at least during a specific time. The store entry apparatus 40 is, for example, an automatic door or a gate. The registration terminal 20 is installed in the store entry apparatus 40 or near the store entry apparatus 40. A customer passes through the store entry apparatus 40 when entering the store. Determination as to whether the customer is allowed to pass through the store entry apparatus 40 is controlled by the registration terminal 20.

A customer who is about to enter the store operates the registration terminal 20. The registration terminal 20 includes an image capturing unit, generates face information (hereinafter, described as first face information) of the customer, and also acquires customer unique information. The customer unique information is information uniquely allocated to the customer, and, for example, is card identification information of a card for checkout carried by the customer. Then, the registration terminal 20 allows the customer to pass through the store entry apparatus 40 by controlling the store entry apparatus 40. For example, the registration terminal 20 may open an automatic door, or cause an automatic door to open when the customer stands in front of the automatic door. Note that, in the following description, it is assumed that customer unique information is card identification information.

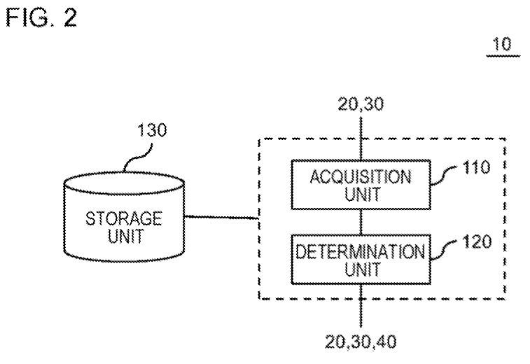

Further, the registration terminal 20 transmits, to the customer management apparatus 10, acquired first face information and card identification information. The customer management apparatus 10 causes a storage unit 130 illustrated in FIG. 2 to store the first face information and the card identification information in association with each other. At this occasion, the first face information is in a state being temporarily registered in the storage unit 130, and is not used as master information for face authentication.

Thereafter, a customer causes the customer terminal 30 to generate face information (hereinafter, described as second face information) of the customer. The customer terminal 30 transmits the generated second face information to the customer management apparatus 10. At this occasion, the customer terminal 30 also acquires attribute information of the customer, and transmits the attribute information to the customer management apparatus 10. A timing at which the customer terminal 30 generates second face information is a timing desired by the customer, for example, a timing when the customer stays at home. Therefore, it is often a case that quality of second face information is higher than quality of first face information. In view of this, the customer management apparatus 10 stores, as master information for face authentication, second face information in association with card identification information. At this occasion, the customer management apparatus 10 determines first face information in which a score with respect to second face information is equal to or more than a criterion value, and the score is highest, and associates the second face information with card identification information associated with the first face information. Further, the customer management apparatus 10 stores attribute information of the customer in association with the second face information.

Thereafter, when entering the store, the customer inputs card identification information or face information to the registration terminal 20. In a case where input card identification information is already registered, the customer management apparatus 10 allows the customer to pass through the store entry apparatus 40 via the registration terminal 20. Further, in a case where second face information in which a score with respect to input face information becomes equal to or more than a criterion value is present, the customer management apparatus 10 allows the customer to pass through the store entry apparatus 40 via the registration terminal 20.

Herein, there is a case in which the customer management apparatus 10 handles a plurality of stores. In this case, a customer registers first face information and card identification information in the customer management apparatus 10 at any one of the stores, and thereafter, registers second face information. Then, the customer is only needed to input either one of the card identification information and the face information to the registration terminal 20 even when entering another one of the stores.

Note that, when first face information and card identification information are transmitted to the customer management apparatus 10, the registration terminal 20 also transmits, to the customer management apparatus 10, information (hereinafter, described as store identification information) for identifying a store in which the registration terminal 20 is installed. However, in a case where the customer management apparatus 10 does not need to use store identification information, the registration terminal 20 does not have to transmit the store identification information to the customer management apparatus 10.

FIG. 2 is a diagram illustrating one example of a functional configuration of the customer management apparatus 10. The customer management apparatus 10 includes an acquisition unit 110 and a determination unit 120. The acquisition unit 110 acquires first face information and card identification information from the registration terminal 20. When the first face information satisfies a first criterion regarding whether authentication is possible, the determination unit 120 causes the storage unit 130 to store the first face information and the card identification information in association with each other (first registration processing), and performs processing for allowing a customer to enter a store. In a case where the store entry apparatus 40 illustrated in FIG. 1 is an automatic door, the processing may be, for example, issuing, to the store entry apparatus 40, a command to open the automatic door, or may be issuing, to the store entry apparatus 40, a command (so-called unlocking) to cause the automatic door to open when the customer stands in front of the automatic door.

Further, after causing the storage unit 130 to store the first face information and the card identification information, the acquisition unit 110 acquires, from the customer terminal 30, second face information of the customer, and attribute information of the customer. Further, the determination unit 120 determines whether the second face information satisfies a second criterion. The second criterion is a criterion regarding whether authentication is possible, and is higher than the first criterion. Further, when the second face information satisfies the second criterion, the determination unit 120 determines first face information associated with the second face information. Then, the determination unit 120 causes the storage unit 130 to store the second face information and the attribute information in association with the card identification information associated with the determined first face information (second registration processing).

Note that, in a case where the registration terminal 20 transmits store identification information to the customer management apparatus 10, the customer management apparatus 10 also acquires the store identification information. Further, when causing the storage unit 130 to store first face information and card identification information, the determination unit 120 also causes the storage unit 130 to store the store identification information.

In the example illustrated in FIG. 2, the storage unit 130 is a part of the customer management apparatus 10. However, the storage unit 130 may be an apparatus outside of the customer management apparatus 10.

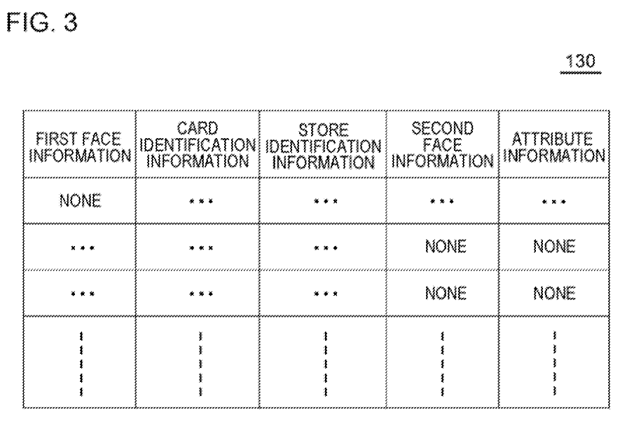

FIG. 3 is a diagram illustrating one example of information stored in the storage unit 130. In the example illustrated in FIG. 3, the storage unit 130 includes an area for storing first face information, an area for storing card identification information, an area for storing store identification information, an area for storing second face information, and an area for storing attribute information. The attribute information includes, for example, at least one of a name, age or an age group, gender, and an address of the customer. There is a case in which the storage unit 130 stores first face information, card identification information, and store identification information, but does not store second face information and attribute information associated with these pieces of information. This is because registration processing of second face information and attribute information has not yet been performed. Further, in the example illustrated in FIG. 3, when second face information and attribute information are stored in the storage unit 130, first face information is deleted from the storage unit 130. This is because, once second face information is registered as master information, first face information is not necessary.

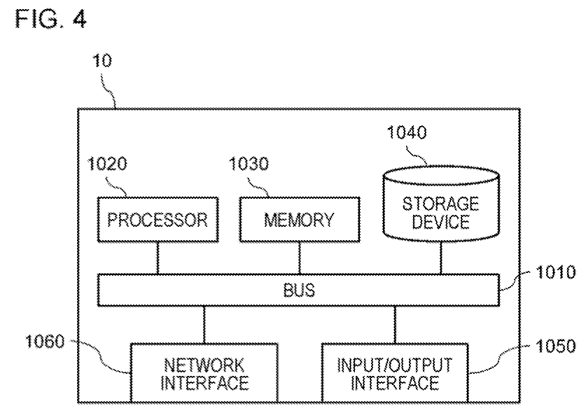

FIG. 4 is a diagram illustrating a hardware configuration example of the customer management apparatus 10. The customer management apparatus 10 includes a bus 1010, a processor 1020, a memory 1030, a storage device 1040, an input/output interface 1050, and a network interface 1060.

The bus 1010 is a data transmission path along which the processor 1020, the memory 1030, the storage device 1040, the input/output interface 1050, and the network interface 1060 mutually transmit and receive data. However, a method of mutually connecting the processor 1020 and the like is not limited to bus connection.

The processor 1020 is a processor achieved by a central processing unit (CPU), a graphics processing unit (GPU), or the like.

The memory 1030 is a main storage achieved by a random access memory (RAM) or the like.

The storage device 1040 is an auxiliary storage achieved by a hard disk drive (HDD), a solid state drive (SSD), a memory card, a read only memory (ROM), or the like. The storage device 1040 stores a program module achieving each function (e.g., the acquisition unit 110 and the determination unit 120) of the customer management apparatus 10. The processor 1020 achieves each function associated with the program module by reading each program module in the memory 1030 and executing each program module. Further, the storage device 1040 also functions as the storage unit 130.

The input/output interface 1050 is an interface for connecting the customer management apparatus 10 to an input/output device of each type.

The network interface 1060 is an interface for connecting the customer management apparatus 10 to a network. The network is, for example, a local area network (LAN) or a wide area network (WAN). A method of connecting the network interface 1060 to a network may be wireless connection, or may be wired connection. The customer management apparatus 10 communicates with the registration terminal 20 and the customer terminal 30 via the network interface 1060.

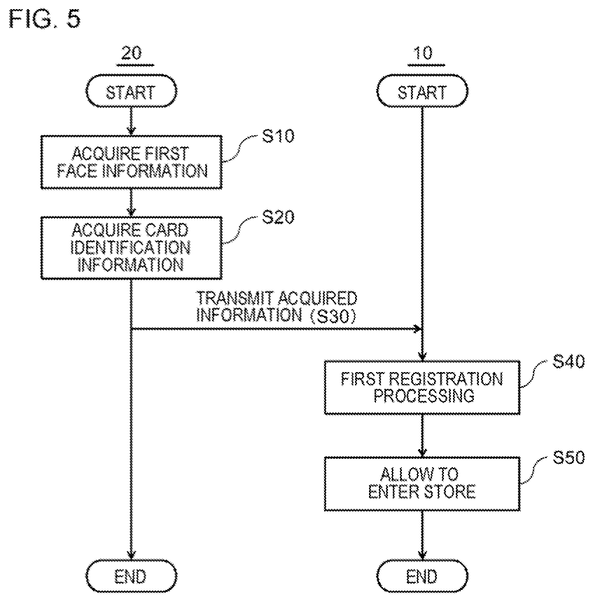

FIG. 5 is a flowchart illustrating first processing to be performed by the customer management apparatus 10. FIG. 5 illustrates processing to be performed by the customer management apparatus 10 when a customer enters a store for the first time.

A customer operates the registration terminal 20 when entering a store. For example, the customer performs a predetermined input with respect to an input unit (e.g., a button or a touch panel) provided on the registration terminal 20. Then, an image capturing unit provided in the registration terminal 20 generates face information of the customer, and sets the face information as first face information (step S10).

Further, the registration terminal 20 requests the customer for card identification information. Then, the customer inputs the card identification information to the registration terminal 20. The input is performed, for example, by causing the registration terminal 20 to read a storage medium (such as an IC chip or a magnetic tape) included in the card (step S20).

Then, the registration terminal 20 transmits, to the customer management apparatus 10, the acquired information, specifically, the first face information and the card identification information. At this occasion, the registration terminal 20 also transmits, to 10, store identification information of the store (step S30).

The acquisition unit 110 of the customer management apparatus 10 acquires the first face information, the card identification information, and the store identification information transmitted from the registration terminal 20. Then, the determination unit 120 of the customer management apparatus 10 causes the storage unit 130 to register the first face information, the card identification information, and the store identification information acquired by the acquisition unit 110 in association with one another (first registration processing: step S40). In the first processing, the determination unit 120 prevents the first face information and the card identification information from being associated with attribute information of the customer. Thereafter, the determination unit 120 performs processing for allowing the customer to enter the store (step S50). For example, the determination unit 120 transmits, to the registration terminal 20, an instruction to allow the customer to pass through the store entry apparatus 40.

Note that, after step S30, the registration terminal 20 may allow the customer to pass through the store entry apparatus 40 without receiving an instruction from the customer management apparatus 10.

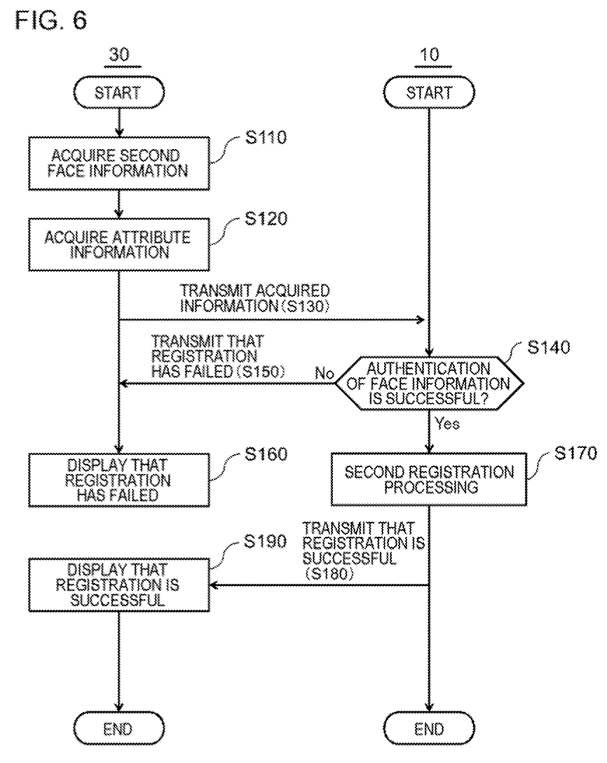

FIG. 6 is a flowchart illustrating second processing to be performed by the customer management apparatus 10. FIG. 6 illustrates processing for registering second face information in the customer management apparatus 10 by a customer.

A customer generates second face information of the customer by operating an image capturing unit of the customer terminal 30 (step S110). Further, the customer inputs, to the customer terminal 30, attribute information of the customer (step S120). Then, the customer terminal 30 transmits, to the customer management apparatus 10, the second face information and the attribute information (step S130). Herein, the customer terminal 30 may transmit, to the customer management apparatus 10, information for communicating with the customer terminal 30. The information is, for example, a telephone number of the customer terminal 30 or an account of an SNS.

The acquisition unit 110 of the customer management apparatus 10 acquires the second face information and the attribute information from the customer terminal 30. Subsequently, the determination unit 120 of the customer management apparatus 10 determines whether the second face information satisfies a second criterion. The second criterion is, as described above, a criterion regarding whether authentication is possible, and is higher than the first criterion. When the second face information satisfies the second criterion, the determination unit 120 determines first face information associated with the second face information. For example, the determination unit 120 determines first face information in which a matching degree with respect to the second face information is equal to or more than a criterion value, and the matching degree is highest (step S140: Yes). Then, the determination unit 120 determines card identification information associated with the first face information determined in step S140, and causes the storage unit 130 to store the second face information and the attribute information in association with the card information (second registration processing: step S170). At this occasion, the determination unit 120 may further cause the storage unit 130 to store information for communicating with the customer terminal 30.

Then, the determination unit 120 transmits, to the customer terminal 30, information indicating that the second registration processing is successful (step S180). The customer terminal 30 displays that the second registration processing is successful (step S190).

Note that, when the second face information does not satisfy the second criterion, or when first face information associated with the second face information cannot be determined (step S140: No), the determination unit 120 transmits, to the customer terminal 30, information indicating that registration of the second face information has failed (step S150). The customer terminal 30 displays that the second registration processing has failed (step S160).

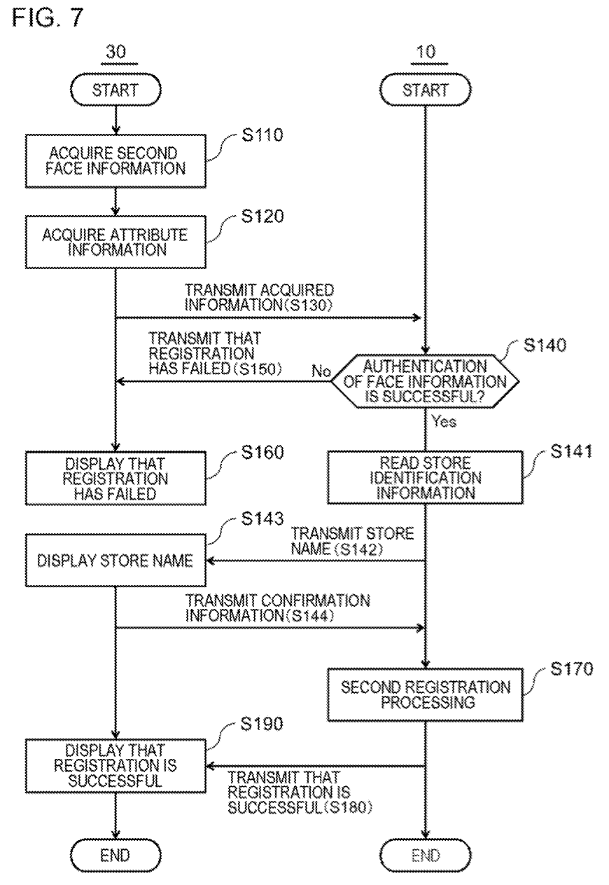

FIG. 7 is a flowchart illustrating third processing to be performed by the customer management apparatus 10. FIG. 7 illustrates a modification example of FIG. 6. In the present modification example, the customer management apparatus 10 allows a customer to confirm a store in which first face information is generated at a time of registering second face information.

In FIG. 7, pieces of processing indicated in step S110 to step S160, and step S170 to step S190 are similar to those in FIG. 6.

When the determination unit 120 determines first face information associated with second face information (step S140: Yes), the determination unit 120 reads, from the storage unit 130, store identification information associated with the first face information (step S141), and transmits, to the customer terminal 30, information related to a store indicated by the store identification information, for example, a store name (step S142).

The customer terminal 30 displays the information acquired from the customer management apparatus 10, for example, a store name (step S143). When a customer confirms that the information displayed on the customer terminal 30 is correct, the customer performs an input to that effect to the customer terminal 30. Then, the customer terminal 30 transmits, to the customer management apparatus 10, information indicating that the customer has confirmed the information related to the store (step S144). Thereafter, the customer management apparatus 10 performs second registration processing (step S170).

Note that, although not illustrated, in a case where information displayed on the customer terminal 30 is not correct, the customer performs an input to that effect to the customer terminal 30. Then, the customer terminal 30 transmits, to the customer management apparatus 10, information indicating that the information related to the store is not correct. In response to acquiring the information, the customer management apparatus 10 does not perform second registration processing.

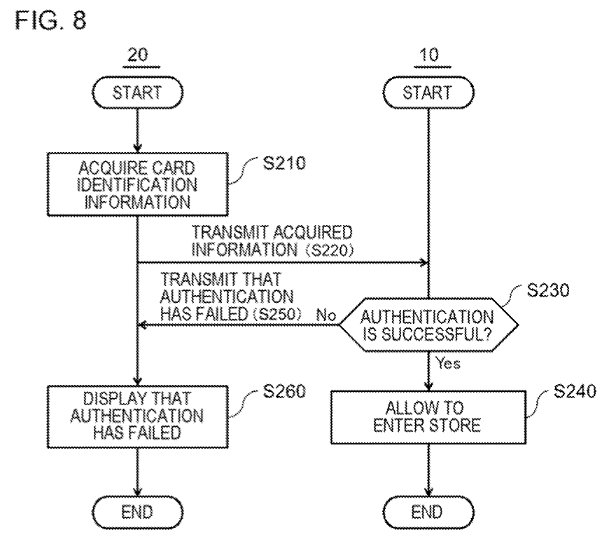

FIG. 8 is a flowchart illustrating fourth processing to be performed by the customer management apparatus 10. FIG. 8 illustrates a first example in which, after a customer performs second registration processing, the customer enters a store. Note that, the store that the customer is about to enter may be a store (first store) in which first registration processing has been performed, or may be a store (second store) different from the first store.

At a time of entering a store, a customer inputs, to the registration terminal 20, card identification information of the customer, as information for authentication (step S210). Then, the registration terminal 20 transmits, to the customer management apparatus 10, the input card identification information (step S220).

The acquisition unit 110 of the customer management apparatus 10 acquires the card identification information from the registration terminal 20. Subsequently, the determination unit 120 of the customer management apparatus 10 determines whether the card identification information is actually registered in the storage unit 130, specifically, whether the card identification information is associated with second face information in the storage unit 130. In a case where the card identification information is actually registered, the determination unit 120 determines that authentication of the card identification information is successful (step S230: Yes), allows the customer to enter the store, and performs processing for causing the customer to enter the store (step S240).

On the other hand, in a case where the card identification information is not actually registered in the storage unit 130, the determination unit 120 determines that authentication of the card identification information has failed (step S230: No), and transmits, to the registration terminal 20, information indicating that authentication has failed (step S250). Then, the registration terminal 20 displays information to that effect, and causes the customer to recognize that authentication has failed (step S260).

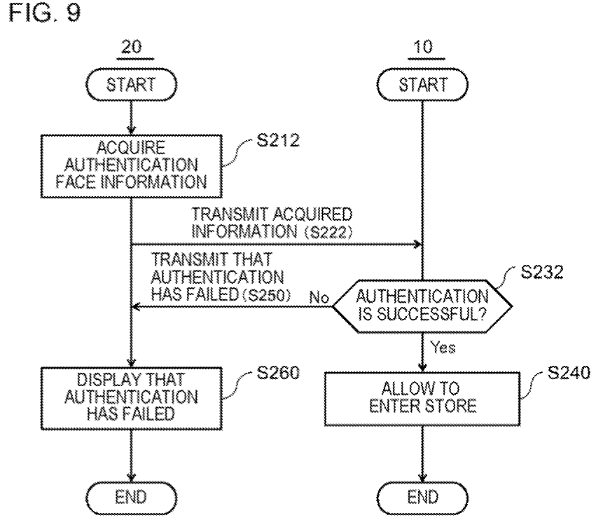

FIG. 9 is a flowchart illustrating fifth processing to be performed by the customer management apparatus 10. FIG. 9 illustrates a second example in which, after a customer performs second registration processing, the customer enters a store. Also in FIG. 9, the store that the customer is about to enter may be a store (first store) in which first registration processing has been performed, or may be a store (second store) different from the first store.

In the example illustrated in FIG. 9, when entering a store, a customer causes the image capturing unit of the registration terminal 20 to generate face information of the customer. The registration terminal 20 sets the face information as authentication face information (step S212). Then, the registration terminal 20 transmits the authentication face information to the customer management apparatus 10 (step S222).

The acquisition unit 110 of the customer management apparatus 10 acquires the authentication face information from the registration terminal 20. Subsequently, the determination unit 120 of the customer management apparatus 10 determines whether collation of the authentication face information is successful with respect to any of pieces of second face information, specifically, whether second face information in which a score with respect to the authentication face information is equal to or more than a criterion value is stored in the storage unit 130. In a case where second face information is stored in the storage unit 130, the determination unit 120 determines that authentication of the authentication face information is successful (step S232: Yes), allows the customer to enter the store, and performs processing for causing the customer to enter the store (step S240).

On the other hand, in a case where second face information associated with the authentication face information is not stored in the storage unit 130, the determination unit 120 determines that authentication of the authentication face information has failed (step S232: No), and transmits, to the registration terminal 20, information indicating that authentication has failed (step S250). Then, the registration terminal 20 displays information to that effect, and causes the customer to recognize that authentication has failed (step S260).

As described above, according to the present example embodiment, it is not necessary to register face information as master information before a customer enters a store for the first time. In place of the above, a customer causes the registration terminal 20 of a store that the customer is about to enter to generate first face information of the customer, and acquire card identification information of a card for checkout. Thus, in a case where a store is operated by a small number of people or in an unstaffed manner, a requirement level of safety within the store can be set to an appropriate state.

Further, after entering a store for the first time, a customer can register, in the customer management apparatus 10, second face information of the customer generated by the customer terminal 30, as master information for face authentication. In most cases, quality of second face information is higher than quality of first face information. Further, the customer management apparatus 10 can associate second face information with card identification information associated with first face information matching the second face information. Therefore, load on the customer is reduced.

### Second Example Embodiment

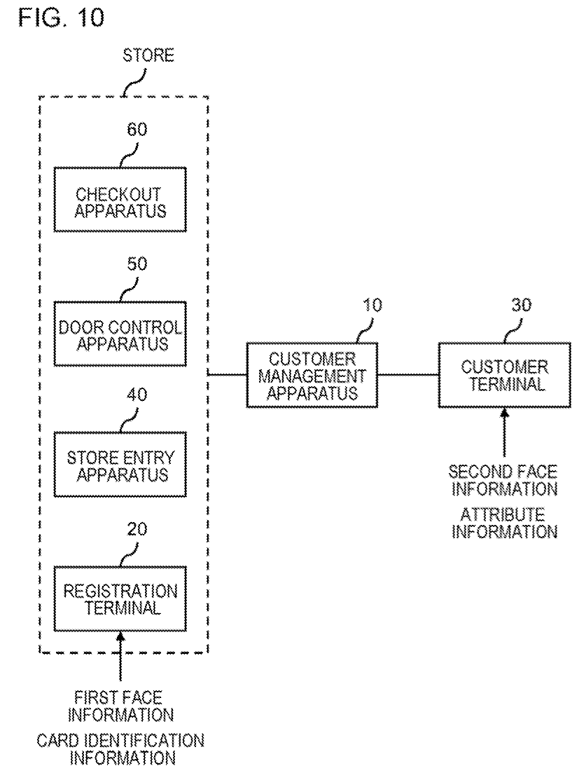

FIG. 10 is a diagram illustrating a usage environment of a customer management apparatus 10 according to a present example embodiment. In the present example embodiment, the customer management apparatus 10 is similar to the customer management apparatus 10 according to the first example embodiment except for a point that the customer management apparatus 10 communicates with a door control apparatus 50 and a checkout apparatus 60 in a store.

The door control apparatus 50 controls locking of a door of a product shelf installed within a store. A product (hereinafter, described as a specific product) such as liquor and cigarettes, which is allowed to be sold only to a customer whose attribute information satisfies a criterion, are placed on the product shelf. The door control apparatus 50 includes an image capturing unit. The image capturing unit generates face information of a customer trying to open the door. The customer management apparatus 10 reads, from a storage unit 130, attribute information associated with the face information, and causes the door control apparatus 50 to unlock the door only in a case where the attribute information (e.g., age) satisfies a criterion.

Further, the checkout apparatus 60 includes an image capturing unit. The image capturing unit generates face information of a customer trying to purchase a product. The customer management apparatus 10 reads, from the storage unit 130, card identification information associated with the face information, and causes the checkout apparatus 60 to perform checkout processing by using the card identification information. Further, in a case where a product that a customer is about to purchase includes the above-described specific product, the customer management apparatus 10 reads, from the storage unit 130, attribute information associated with the face information generated by the checkout apparatus 60, and only in a case where the attribute information satisfies a criterion, the customer management apparatus 10 causes the checkout apparatus 60 to perform checkout processing.

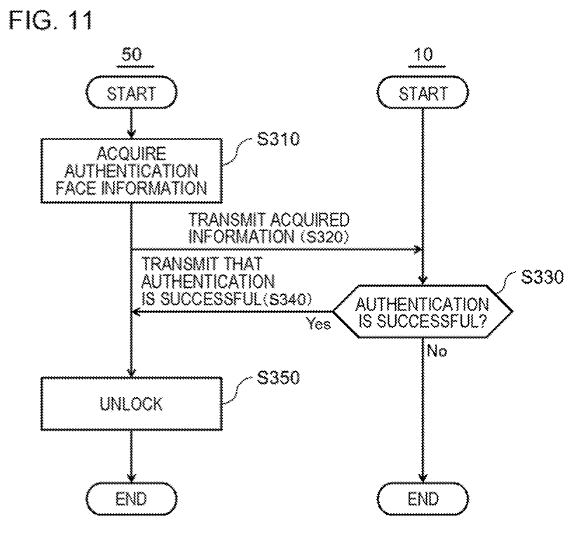

FIG. 11 is a flowchart illustrating processing to be performed by the customer management apparatus 10 when a customer takes out a specific product from a product shelf. First, the image capturing unit of the door control apparatus 50 generates face information (hereinafter, described as authentication face information) of a customer standing in front of the product shelf (step S310), and transmits the authentication face information to the customer management apparatus 10 (step S320).

An acquisition unit 110 of the customer management apparatus 10 acquires the authentication face information from the door control apparatus 50. Subsequently, in a case where second face information in which a score with respect to the authentication face information becomes equal to or more than a criterion value is stored in the storage unit 130, a determination unit 120 of the customer management apparatus 10 reads, from the storage unit 130, attribute information associated with the second face information. At this occasion, in a case where scores of a plurality of pieces of second face information become equal to or more than a criterion value, the determination unit 120 selects a piece of the second face information in which the score is highest. Then, in a case where the read attribute information satisfies a criterion (e.g., in a case where age is the same as or older than an adult age), the determination unit 120 determines that authentication of the customer is successful (step S330: Yes), and transmits, to the door control apparatus 50, information indicating that authentication is successful (step S340). Then, the door control apparatus 50 unlocks the door (step S350). Thus, the customer is allowed to take out the specific product from the product shelf.

On the other hand, in a case where second face information in which a score with respect to the authentication face information becomes equal to or more than the criterion value is not stored in the storage unit 130, or in a case where the read attribute information does not satisfy the criterion, the determination unit 120 determines that authentication of the customer has failed (step S330: No). In this case, the door control apparatus 50 does not unlock the door.

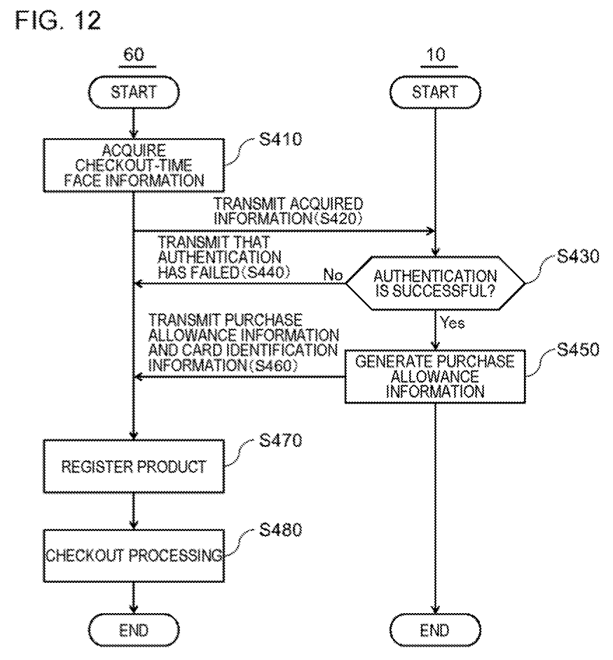

FIG. 12 is a flowchart illustrating processing to be performed by the customer management apparatus 10 when a customer performs checkout processing of a product by using the checkout apparatus 60. First, the image capturing unit of the checkout apparatus 60 generates face information (hereinafter, described as checkout-time face information) of a customer trying to perform checkout (step S410), and transmits the checkout-time face information to the customer management apparatus 10 (step S420).

The acquisition unit 110 of the customer management apparatus 10 acquires the checkout-time face information from the checkout apparatus 60. Subsequently, in a case where second face information in which a score with respect to the checkout-time face information becomes equal to or more than a criterion value is stored in the storage unit 130, the determination unit 120 of the customer management apparatus 10 reads, from the storage unit 130, card identification information and attribute information associated with the second face information. At this occasion, in a case where scores of a plurality of pieces of second face information become equal to or more than the criterion value, the determination unit 120 selects a piece of the second face information in which the score is highest. Then, in a case where the read attribute information satisfies a criterion (e.g., in a case where age is the same as or older than an adult age), the determination unit 120 determines that authentication of the customer is successful (step S430). Then, the determination unit 120 generates information (hereinafter, described as purchase allowance information) indicating that purchase of a specific product is allowed (step S450), and transmits, to the checkout apparatus 60, the purchase allowance information together with the card identification information (step S460).

On the other hand, in a case where second face information in which a score with respect to the authentication face information becomes equal to or more than the criterion value is not stored in the storage unit 130, or in a case where the read attribute information does not satisfy the criterion, the determination unit 120 determines that authentication of the customer has failed, and transmits, to the checkout apparatus 60, information indicating that authentication has failed (step S440). Note that, in a case where second face information in which a score with respect to the checkout-time face information becomes equal to or more than the criterion value is stored in the storage unit 130, but attribute information does not satisfy the criterion, the determination unit 120 reads, from the storage unit 130, card identification information associated with the second face information, and transmits, to the checkout apparatus 60, the card identification information together with information indicating that authentication has failed.

Then, the checkout apparatus 60 performs registration processing of a product by using the information acquired from the customer management apparatus 10 (step S470). Specifically, in a case where the checkout apparatus 60 acquires, from the customer management apparatus 10, information indicating that authentication has failed, the checkout apparatus 60 does not allow registration of the specific product. On the other hand, in a case where the checkout apparatus 60 acquires purchase allowance information from the customer management apparatus 10, the checkout apparatus 60 allows registration of the specific product.

Thereafter, the checkout apparatus 60 performs checkout processing of the registered product. Herein, in a case where the checkout apparatus 60 acquires card identification information from the customer management apparatus 10, the checkout apparatus 60 electronically performs checkout processing by using the card identification information (step S480).

As described above, also in the present example embodiment, an advantageous effect similar to that of the first example embodiment is acquired. Further, by face authentication using second face information, a specific product can be taken out from a product shelf, and checkout processing of a product can be performed. Therefore, the number of staff necessary in a store can be reduced. Further, checkout processing of a product can be performed by using card identification information registered when a customer enters a store for the first time. Therefore, a customer does not need to carry a card for checkout at a time of checkout.

As described above, while example embodiments according to the present invention have been described with reference to the drawings, these example embodiments are an example of the present invention, and various configurations other than the above can also be adopted.

Further, in a plurality of flowcharts used in the above description, a plurality of processes (pieces of processing) are described in order, but an order of execution of processes to be performed in each example embodiment is not limited to the order of description. In each example embodiment, the order of illustrated processes can be changed within a range that does not adversely affect a content. Further, the above-described example embodiments can be combined, as far as contents do not conflict with each other.

A part or whole of the above-described example embodiments may also be described as the following supplementary notes, but is not limited thereto.
1. A customer management apparatus including:
   an acquisition unit that acquires, from a registration terminal installed at an entrance of a first store, first face information of a customer who wishes to enter the first store, and customer unique information being information uniquely allocated to the customer; and,
   when the first face information satisfies a first criterion regarding whether authentication is possible, a determination unit that performs first registration processing of causing a storage unit to store the first face information and the customer unique information in association with each other.
2. The customer management apparatus according to supplementary note 1, wherein
   the customer unique information is card identification information of a card for checkout carried by the customer.
3. The customer management apparatus according to supplementary note 1 or 2, wherein
   the determination unit performs the first registration processing, and performs processing for allowing the customer to enter the first store.
4. The customer management apparatus according to any one of supplementary notes 1 to 3, wherein,
   when the customer is allowed to enter the first store, the determination unit prevents the first face information and the customer unique information from being associated with attribute information of the customer.
5. The customer management apparatus according to any one of supplementary notes 1 to 4, wherein,
   after the storage unit stores the first face information and the customer unique information, the acquisition unit acquires second face information of the customer, and attribute information of the customer, and,
   when the second face information satisfies a second criterion being a criterion regarding whether authentication is possible and being higher than the first criterion, the determination unit
      determines the first face information associated with the second face information, and
      performs second registration processing of causing the storage unit to store the second face information and the attribute information in association with the customer unique information associated with the determined first face information.
6. The customer management apparatus according to supplementary note 5, wherein,
   when the first registration processing is performed, the acquisition unit acquires, together with the first face information, store identification information for identifying the first store,
   the determination unit causes the storage unit to store the store identification information in association with the first face information, and,
   when the second registration processing is performed, the determination unit reads the store identification information associated with the determined first face information, and transmits, to a terminal operated by the customer, information related to a store indicated by the store identification information.
7. The customer management apparatus according to supplementary note 5 or 6, wherein,
   after the second registration processing is performed, the determination unit
      acquires, from a checkout apparatus in the first store or in a second store different from the first store, checkout-time face information being face information of the customer who is about to do checkout,
      in a case where the attribute information associated with the checkout-time face information satisfies a criterion, generates purchase allowance information indicating that the customer is allowed to purchase a specific product, and
      transmits the purchase allowance information to the checkout apparatus.
8. The customer management apparatus according to supplementary note 7, wherein
   the attribute information includes age of the customer.
9. The customer management apparatus according to any one of supplementary notes 5 to 8, wherein,
   after the second registration processing is performed, the determination unit,
      when the customer enters the first store, acquires the customer unique information of the customer, as customer unique information for authentication, and,
      when collation of the customer unique information for authentication is successful with respect to any of pieces of the customer unique information stored in the storage unit, allows the customer to enter the first store.
10. The customer management apparatus according to any one of supplementary notes 5 to 8, wherein,
   after the second registration processing is performed, the determination unit,
      when the customer enters the first store, acquires authentication face information of the customer, and,
      when collation of the authentication face information is successful with respect to any of pieces of the second face information stored in the storage unit, allows the customer to enter the first store.
11. The customer management apparatus according to supplementary note 9 or 10, wherein,
   after the second registration processing is performed, the determination unit determines whether the customer is allowed to enter a second store different from the first store at a same criterion as the first store.
12. A customer management method including,
   by a computer:
      acquiring, from a registration terminal installed at an entrance of a first store, first face information of a customer who wishes to enter the first store, and customer unique information being information uniquely allocated to the customer; and,
      when the first face information satisfies a first criterion regarding whether authentication is possible, performing first registration processing of causing a storage unit to store the first face information and the customer unique information in association with each other.
13. The customer management method according to supplementary note 12, wherein
   the customer unique information is card identification information of a card for checkout carried by the customer.
14. The customer management method according to supplementary note 12 or 13, further including,
   by the computer,
   performing the first registration processing, and performing processing for allowing the customer to enter the first store.
15. The customer management method according to any one of supplementary notes 12 to 14, further including,
   by the computer,
   when the customer is allowed to enter the first store, preventing the first face information and the customer unique information from being associated with attribute information of the customer.
16. The customer management method according to any one of supplementary notes 12 to 15, further including,
   by the computer:
   after the storage unit stores the first face information and the customer unique information, acquiring second face information of the customer, and attribute information of the customer;
   when the second face information satisfies a second criterion being a criterion regarding whether authentication is possible, and being higher than the first criterion,
      determining the first face information associated with the second face information; and
      performing second registration processing of causing the storage unit to store the second face information and the attribute information in association with the customer unique information associated with the determined first face information.
17. The customer management method according to supplementary note 16, further including,
   by the computer:
      when the first registration processing is performed, acquiring, together with the first face information, store identification information for identifying the first store;
      causing the storage unit to store the store identification information in association with the first face information; and,
      when the second registration processing is performed, reading the store identification information associated with the determined first face information, and transmitting, to a terminal operated by the customer, information related to a store indicated by the store identification information.
18. The customer management method according to supplementary note 16 or 17, further including,
   by the computer:
   after the second registration processing is performed,
      acquiring, from a checkout apparatus in the first store or in a second store different from the first store, checkout-time face information being face information of the customer who is about to do checkout;
      in a case where the attribute information associated with the checkout-time face information satisfies a criterion, generating purchase allowance information indicating that the customer is allowed to purchase a specific product; and
      transmitting the purchase allowance information to the checkout apparatus.
19. The customer management method according to supplementary note 18, wherein
   the attribute information includes age of the customer.
20. The customer management method according to any one of supplementary notes 16 to 19, further including,
   by the computer:
   after the second registration processing is performed,
      when the customer enters the first store, acquiring the customer unique information of the customer, as customer unique information for authentication; and,
      when collation of the customer unique information for authentication is successful with respect to any of pieces of the customer unique information stored in the storage unit, allowing the customer to enter the first store.
21. The customer management method according to any one of supplementary notes 16 to 19, further including,
   by the computer:
   after the second registration processing is performed,
      when the customer enters the first store, acquiring authentication face information of the customer; and,
      when collation of the authentication face information is successful with respect to any of pieces of the second face information stored in the storage unit, allowing the customer to enter the first store.
22. The customer management method according to supplementary note 20 or 21, further including,
   by the computer:
   after the second registration processing is performed, determining whether the customer is allowed to enter a second store different from the first store at a same criterion as the first store.
23. A program causing a computer to execute:
   an acquisition function of acquiring, from a registration terminal installed at an entrance of a first store, first face information of a customer who wishes to enter the first store, and customer unique information being information uniquely allocated to the customer; and,
   when the first face information satisfies a first criterion regarding whether authentication is possible, a determination function of performing first registration processing of causing a storage unit to store the first face information and the customer unique information in association with each other, and performing processing for allowing the customer to enter the first store.
24. The program according to supplementary note 23, wherein
   the customer unique information is card identification information of a card for checkout carried by the customer.
24. The program according to supplementary note 23 or 24, wherein
   the determination function performs the first registration processing, and performs processing for allowing the customer to enter the first store.
26. The program according to any one of supplementary notes 23 to 25, wherein,
   when the customer is allowed to enter the first store, the determination function prevents the first face information and the customer unique information from being associated with attribute information of the customer.
27. The program according to any one of supplementary notes 23 to 26, wherein,
   after the storage unit stores the first face information and the customer unique information, the acquisition function acquires second face information of the customer, and attribute information of the customer, and,
   when the second face information satisfies a second criterion being a criterion regarding whether authentication is possible and being higher than the first criterion, the determination function
      determines the first face information associated with the second face information, and
      performs second registration processing of causing the storage unit to store the second face information and the attribute information in association with the customer unique information associated with the determined first face information.
28. The program according to supplementary note 27, wherein,
   when the first registration processing is performed, the acquisition function acquires, together with the first face information, store identification information for identifying the first store,
   the determination function causes the storage unit to store the store identification information in association with the first face information, and,
   when the second registration processing is performed, the determination function reads the store identification information associated with the determined first face information, and transmits, to a terminal operated by the customer, information related to a store indicated by the store identification information.
29. The program according to supplementary note 27 or 28, wherein,
   after the second registration processing is performed, the determination function
      acquires, from a checkout apparatus in the first store or in a second store different from the first store, checkout-time face information being face information of the customer who is about to do checkout,
      in a case where the attribute information associated with the checkout-time face information satisfies a criterion, generates purchase allowance information indicating that the customer is allowed to purchase a specific product, and
      transmits the purchase allowance information to the checkout apparatus.
30. The program according to supplementary note 29, wherein
   the attribute information includes age of the customer.
31. The program according to any one of supplementary notes 27 to 30, wherein,
   after the second registration processing is performed, the determination function,
      when the customer enters the first store, acquires the customer unique information of the customer, as customer unique information for authentication, and,
      when collation of the customer unique information for authentication is successful with respect to any of pieces of the customer unique information stored in the storage unit, allows the customer to enter the first store.
32. The program according to any one of supplementary notes 27 to 30, wherein,
   after the second registration processing is performed, the determination function,
      when the customer enters the first store, acquires authentication face information of the customer, and,
      when collation of the authentication face information is successful with respect to any of pieces of the second face information stored in the storage unit, allows the customer to enter the first store.
33. The program according to supplementary note 31 or 32, wherein,
   after the second registration processing is performed, the determination function determines whether the customer is allowed to enter a second store different from the first store at a same criterion as the first store.

This application is based upon and claims the benefit of priority from Japanese patent application No. 2020-034685, filed on Mar. 2, 2020, the disclosure of which is incorporated herein in its entirety by reference.

### REFERENCE SIGNS LIST

10 Customer management apparatus
20 Registration terminal
30 Customer terminal
40 Store entry apparatus
50 Door control apparatus
60 Checkout apparatus
110 Acquisition unit
120 Determination unit
130 Storage unit

What is claimed is:

1. A customer management apparatus comprising:
at least one memory configured to store instructions: and
at least one processor configured to execute the instructions to preform operations comprising:
acquiring, from a registration terminal installed at an entrance of a first store, first face information of a customer who wishes to enter the first store, and customer unique information being information uniquely allocated to the customer; and,
when the first face information satisfies a first criterion regarding whether authentication is possible, performing first registration processing of causing a storage to store the first face information and the customer unique information in association with each other.

2. The customer management apparatus according to claim 1, wherein
the customer unique information is card identification information of a card for checkout carried by the customer.

3. The customer management apparatus according to claim 1, wherein the operations further comprise
performing the first registration processing, and performs processing for allowing the customer to enter the first store.

4. The customer management apparatus according to claim 1, wherein the operations further comprise,
when the customer is allowed to enter the first store, preventing the first face information and the customer unique information from being associated with attribute information of the customer.

5. The customer management apparatus according to claim 1, wherein the operations further comprise,
after the storage stores the first face information and the customer unique information, acquiring second face information of the customer, and attribute information of the customer, and,
when the second face information satisfies a second criterion being a criterion regarding whether authentication is possible and being higher than the first criterion
determining the first face information associated with the second face information, and
performing second registration processing of causing the storage to store the second face information and the attribute information in association with the customer unique information associated with the determined first face information.

6. The customer management apparatus according to claim 5, the operations further comprise,
when the first registration processing is performed, acquiring, together with the first face information, store identification information for identifying the first store,
causing the storage to store the store identification information in association with the first face information, and,
when the second registration processing is performed, reading the store identification information associated with the determined first face information, and transmitting to a terminal operated by the customer, information related to a store indicated by the store identification information.

7. The customer management apparatus according to claim 5, wherein the operations further comprise,
after the second registration processing is performed,
acquiring from a checkout apparatus in the first store or in a second store different from the first store, checkout-time face information being face information of the customer who is about to do checkout,
in a case where the attribute information associated with the checkout-time face information satisfies a criterion, generating purchase allowance information indicating that the customer is allowed to purchase a specific product, and
transmitting the purchase allowance information to the checkout apparatus.

8. The customer management apparatus according to claim 7, wherein
the attribute information includes age of the customer.

9. The customer management apparatus according to claim 5, wherein the operations further comprise,
after the second registration processing is performed,
when the customer enters the first store, acquiring the customer unique information of the customer, as customer unique information for authentication, and,
when collation of the customer unique information for authentication is successful with respect to any of pieces of the customer unique information stored in the storage, allowing the customer to enter the first store.

10. The customer management apparatus according to claim 5, wherein the operations further comprise,
after the second registration processing is performed,
when the customer enters the first store, acquiring authentication face information of the customer, and,
when collation of the authentication face information is successful with respect to any of pieces of the second face information stored in the storage, allowing the customer to enter the first store.

11. The customer management apparatus according to claim 9, wherein the operations further comprise,
after the second registration processing is performed, determining whether the customer is allowed to enter a second store different from the first store at a same criterion as the first store.

12. A customer management method comprising,
by a computer:
acquiring, from a registration terminal installed at an entrance of a first store, first face information of a customer who wishes to enter the first store, and customer unique information being information uniquely allocated to the customer; and,
when the first face information satisfies a first criterion regarding whether authentication is possible, performing first registration processing of causing a storage to store the first face information and the customer unique information in association with each other.

13. A non-transitory computer-readable medium storing a program causing a computer to execute:
acquiring, from a registration terminal installed at an entrance of a first store, first face information of a customer who wishes to enter the first store, and customer unique information being information uniquely allocated to the customer; and,
when the first face information satisfies a first criterion regarding whether authentication is possible, performing first registration processing of causing a storage to store the first face information and the customer unique information in association with each other, and performing processing for allowing the customer to enter the first store.

14. The customer management apparatus according to claim 10, wherein the operations further comprise,
after the second registration processing is performed, determining whether the customer is allowed to enter a second store different from the first store at a same criterion as the first store.
